(19) United States
(12) Patent Application Publication
(10) Pub. No.: US 2008/0126225 A1
(43) Pub. Date: May 29, 2008

(54) Intermediary service for application intergration of E-commerce functionality

(75) Inventors: Reeves Briggs, Boxborough, MA (US); Ning Sun, Redmond, WA (US); Lisa Lane, Bellevue, WA (US); Manoj Aggarwal, Seattle, WA (US); Samir Bajaj, Redmond, WA (US); Douglas R. DeFonzo, Newton, MA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/604,925

(22) Filed: Nov. 28, 2006

(51) Int. Cl. G06Q 30/00

(52) U.S. Cl. 705/27

(57) ABSTRACT

A system is disclosed for supporting integration of electronic commerce functionality into an application. The system includes an intermediary service layer that is configured to receive a collection of listing information from an application. The intermediary layer is also configured to electronically communicate a representation of the collection of listing information to an electronic marketplace).

### BACKGROUND

The business management of online sales commonly involves discrete user interactions with multiple software applications. For example, interaction with an online auction application (e.g., to create, track, and follow-up on a sale listing for an item, etc.) is typically distinct from corresponding interaction with an accounting application (e.g., to update inventory records, to record financial implications, etc.). In many cases, users are relied upon to manually transfer transaction information from one application to another. Thus, data accuracy and currency are often contingent upon the effectiveness and efficiency of manual processing.

Further, methods of interaction are not necessarily consistent from one online marketplace to the next. For example, the experience of logging into and interacting with one online account may be very different than the experience of logging into another. Further, systems for compensating a sponsor of a given online marketplace can vary drastically from one service to the next. Users are often relied upon to learn and maneuver through these and many other nuances.

The discussion above is merely provided for general background information and is not intended for use as an aid in determining the scope of the claimed subject matter.

### SUMMARY

A system is disclosed for supporting integration of electronic commerce functionality into an application. The system includes an intermediary service layer that is configured to receive a collection of listing information from an application. The intermediary layer is also configured to electronically communicate a representation of the collection of listing information to an electronic marketplace (120, 122, 124).

This Summary is provided to introduce a selection of concepts in a simplified form that are further described below in the Detailed Description. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic representation of an online sales support system.

FIG. 2 is a schematic process diagram of an initial listing process.

FIGS. 3 and 4 are examples of screenshots provided to a user through an application as part of the initial listing process.

FIG. 5 is a schematic process diagram of a post listing process.

FIG. 6 is an example of a screenshot provided to a user through an application as part of a listing review process.

FIG. 7 illustrates an example of a computing system environment in which embodiments may be implemented.

### DETAILED DESCRIPTION

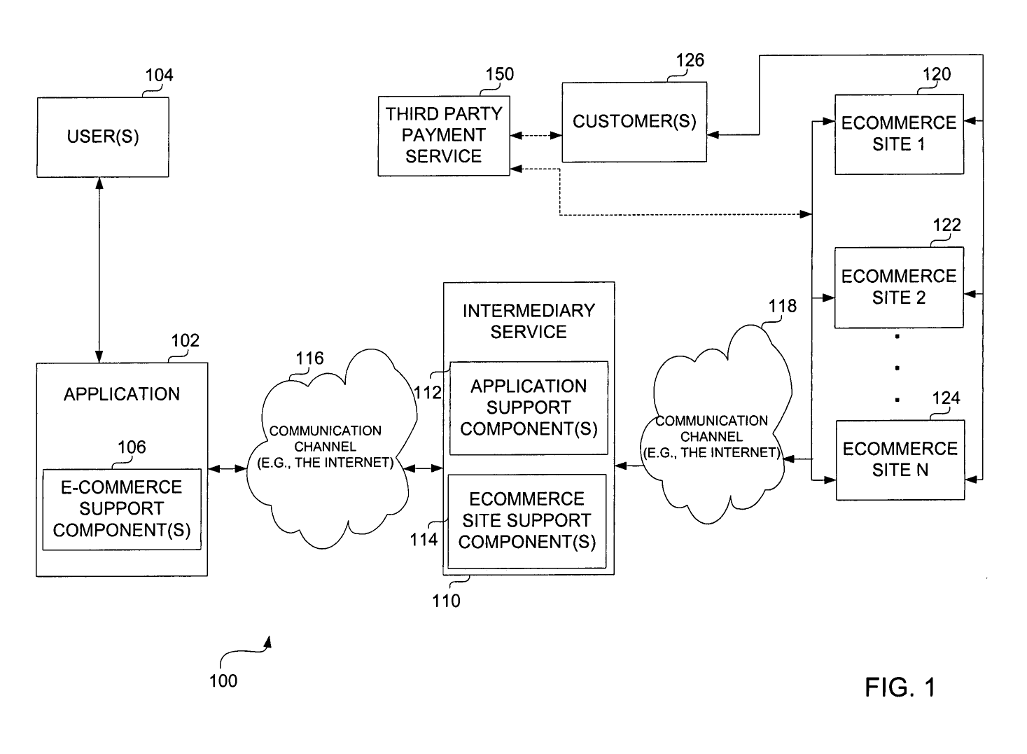

FIG. 1 is a schematic representation of an online sales support system 100. Within system 100, a user 104 interacts with an application 102. Application 102 is illustratively a software application implemented on a computing device. In one embodiment, not by limitation, application 102 is a business application, such as an accounting application or a customer relationship management application.

Application 102 includes an Ecommerce support component 106. Component 106 is a collection of specialized functionality integrated into application 102 to support online business conducted by user 104 with customers 126 through services provided by one or more online merchants. Within FIG. 1, the online merchants are identified as E-commerce web sites 120, 122 and 124.

In one embodiment, not by limitation, at least one of sites 120, 122 and 124 is an auction-based web site through which customers 126 purchase goods from user 104 (or a business associated with user 104. An example of such a site is www.ebay.com, which is associated with Ebay Inc. of San Jose, Calif. In another embodiment, also not by limitation, at least one of sites 120, 122 and 124 is an online shopping environment where a customer 126 can purchase goods or services from a variety of different sellers of which user 104 (or a business associated with user 104) is only one. Examples of such sites are www.half.com and www.ebayexpress.com, both also being associated with Ebay Inc. It is certainly contemplated that sites 120 122 and 124 can include sites other than those sponsored by Ebay Inc. It is to be understood that Ebay sites are provided herein as examples only.

Component 102 is illustratively configured to support transactions with customers 126 through any or all of E-commerce sites 120, 122 and 124 with minimal or no requirement on the part of user 104 to directly access or interact with the associated E-commerce web interface(s). Component 102 facilitates and manages interaction with sites 120 in accordance with instructions and information received from user 104 through application 102 and component 106 interfaces. Further, in one embodiment, functional features of application 102 outside the scope of component 106 are configured to support the E-commerce functionality of component 106. For example, in one embodiment, adjustments are automatically or semi-automatically made to inventory and/or financial records to account for the result of business transactions facilitated by component 106 with customers 126 through one or more of sites 120, 122 and 124. Thus, in one embodiment, rather than simply being a link to the E-commerce sites, component 106 is functionally integrated into application 102.

An intermediary service 110 is provided, in one embodiment, to manage interactions between application 102 and any or all of E-commerce sites 120, 122 and 124. Communication between application 102 and intermediary service 110 occurs over a communication channel 116, illustratively a computer network such as, but not necessarily limited to, the Internet. Communication between intermediary service 110 and the E-commerce sites illustratively occurs over a communication channel 118, illustratively a computer network such as, but not necessarily limited to, the Internet.

Eccommerce support component 106 is illustratively associated with a set of application program interfaces configured to support the transfer of information and commands to and from an application support component 112 that is part of intermediary service 110. Similarly, each of sites 120, 122 and 124 is associated with a set of application program interfaces configured to support the transfer of information and commands to and from an E-commerce site support component 114 that is part of intermediary service 110. Intermediary service 110 is then configured to communicate and/or translate information and commands between components 112 and 114.

In order to further clarify the functionality of system 100, an example will now be provided. For the purposes of the example only, not by limitation, it will be assumed that site 120 is an auction-type E-commerce service, such as that offered at www.ebay.com. Further, it will be assumed that application 102 is an accounting-type business application that includes support for tracking inventory and finances.

In accordance with the example, E-commerce support component 106, together in combination with intermediary service 110, provide functionality that is integrated into application 102 to enable user 104 to sell more easily on site 120. Through application 102 and component 106 interfaces, user 104 transfers, to support components 112, information and commands related to the selection of a product from application 102 inventory, the listing of the product for sale on site 120, the viewing of the status of that listing from within application 102, etc. The information and commands are then relayed through support components 114 to site 120 through application program interfaces exposed by the site.

Thus, in one embodiment, any item in the application 102 inventory can be listed for sale on site 120. User 104 no longer has to work through the standard web interface associated with site 120 to create a new listing. Instead, he or she can enter the data and commands though a screen that is part of application 102.

Those skilled in the art will appreciate that information and commands are returnable following a reverse path. For example, information such as, but not limited to, information related to transactions and fees (e.g., fees charged by site 120) can be transferred from site 120 to application 102 through intermediary service 110. In one embodiment, application 102 is configured to automatically or semi-automatically account for the information in the application 102 functionality (e.g., accounts are debited or credited appropriately, adjustments are made to inventory availability, etc.).

The described integration of E-commerce support functionality into application 102 potentially saves user 104 time. Further, it reduces the risk of error from manually entering online sales information into the application. Still further, in one embodiment, a product can be offered for sale and monitored on more than one of sites 120, 122 and 124 in one central application with a reduced or eliminated need to re-enter information.

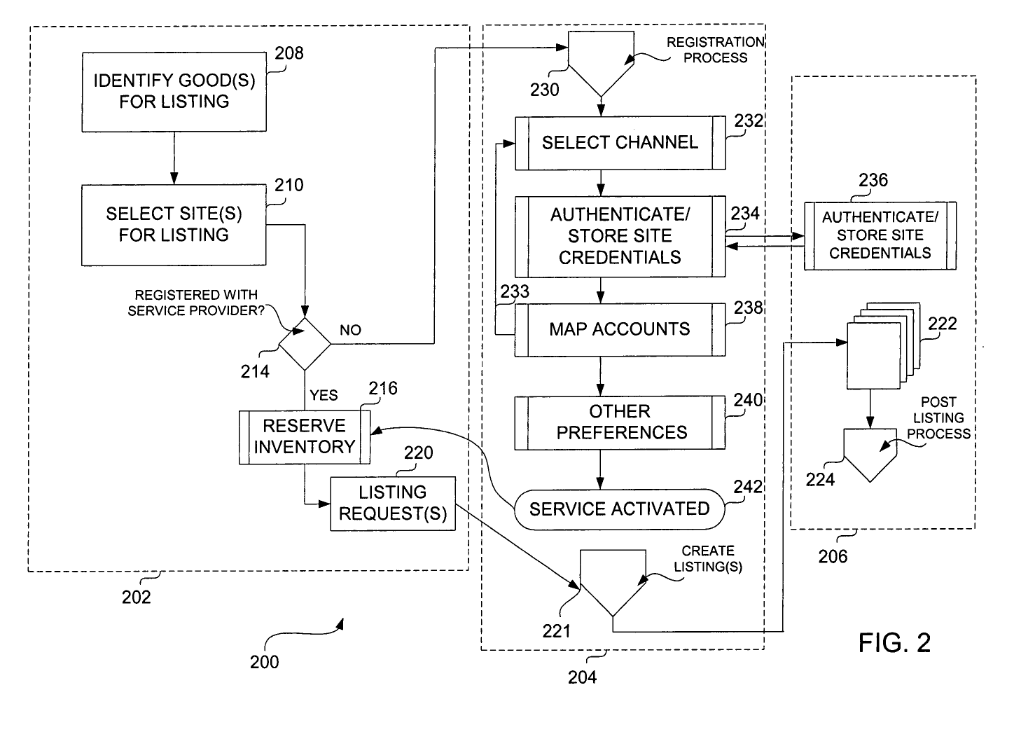

FIG. 2 is a schematic process diagram of an initial listing process 200 that is, in one embodiment, applied within system 100. Those skilled in the art will appreciate that the details of the process flow could vary greatly from one implementation to the next. Flow 200 is but one example of a flow within the scope of the present invention.

Within process 200, process components positioned within dotted box 202 are items illustratively facilitated in the context of application 102. Process components located within dotted box 204 are items illustratively facilitated in the context of intermediary service 110. Process components located within box 206 are items illustratively facilitated in the context of E-commerce sites 120, 122 and/or 124. The illustrated configuration is exemplary only and it is to be understood that process items can be moved from one context to another without departing from the scope of the present invention.

In accordance with box 208, user 104 interacts with an application 102 and/or component 106 interface so as to identify goods to be sold. In one embodiment, this involves selecting an item or items included in an application 102 inventory. In another one embodiment, a user 104 is able to enter an item not included in the application inventory (e.g., a new item is entered and then added to the application 102 inventory).

In accordance with box 210, user 104 interacts with an application 102 and/or component 106 interface so as to select E-commerce sites on which a listing is desired. The user illustratively selects one or more of sites 120, 122 and 124. In one embodiment, the user is presented with a list of sites from which to choose.

In accordance with block 214, a determination is made as to whether the user is set up to do business through intermediary service 110. If the user is set up, then, as is indicated by block 216, the application 102 inventory is updated as necessary (e.g., a notation is made to indicate items that are being offered for sale). A listing request 220 is transmitted to intermediary service 110. Request 220 is indicative of the goods selected in step 208 and the E-commerce sites selected in step 210.

As is indicated by block 221, service 110 receives the listing request 220 and interacts with any or all (depending on instructions in the request) of sites 120, 122 and 124 as necessary to create one or more listings 222. In one embodiment, service 110 has access to user 104's account credentials (e.g., site-specific user names, passwords, etc.) and utilizes them to “log-in” to the user's E-commerce site account(s) in order to act on the user's behalf. In accordance with block 224, once listings 222 have been created, the flow transitions to a post listing process.

If, at block 214, it is determined that the user is not set up to de business through intermediary service 110, then the flow transitions to registration process 230. The registration process is illustratively facilitated by intermediary service 110. During registration, user 104 is illustratively presented with, through support component 106, one or more registration interfaces. The user inputs registration information into those interfaces. The registration information is communicated to service 110 and utilized for registration purposes.

In one embodiment, registration is conducted on a site-specific basis (i.e., the information collected, as well as the steps taken can vary from one site to the next). Consistent with this premise, block 232 represents selection of a particular E-commerce site (i.e., a particular channel of trade). In one embodiment, sites selected in step 232 are sites selected by user 104 in step 210. The selection in step 232 might be initiated by user 104 (e.g., an input in response to a question in the nature of “Which site do you want to register with first?”) or may be automatically initiated (e.g., when only one site is selected in step 210, in a default order, etc.).

As is generally indicated by blocks 234 and 236, service 110 is configured to interact with a site selected in step 232 so as to authenticate and/or store user credentials (e.g., user name, password, etc.). This may involve interacting with the site to authenticate an existing set of credentials (e.g. credentials received from the user during the registration interaction). Alternatively, site 110 may be configured to interact with the site and create a new account with a new set of corresponding credentials (e.g., new account opened based on new account information received from the user during the registration interaction).

In accordance with bock 238, there is a mapping between functionality of the selected site and functionality of application 102. For example, mapping may involve linking fees charged by the site to a particular account maintained within application 102. In addition or alternatively, mapping may involve linking sale proceeds to a particular account. These are just two of many functions that can be mapped in accordance with block 238. In one embodiment, some mapping settings may be automatic (e.g., default settings, mandatory settings for certain sites, etc.). In another embodiment; however, an interactive mapping process carried out wherein user 104 is presented with, through support component 106, one or more mapping interfaces. The user inputs mapping preferences into those interfaces. The mapping preferences are communicated to service 110 (if necessary) and utilized to establish mapping settings. In one embodiment, mapping settings can be pluralistic (e.g., all listing fees for all sites should link to application account X) or site-specific (e.g., a listing fee from site X should map to application account Y).

In one embodiment, mapping is divided into two parts. First, entities specific to an E-commerce site are mapped to a set of generic accounting entities (e.g., the buyer information for site 120 is a “customer”, the shipping line items from an order is “shipping income”, the tax line item is from “sales tax”, the site fee is a “fee”, orders paid by VISA are “credit card payments”, etc.) Second, the generic accounting entities are mapped to specific accounts in the application (e.g., “shipping income” from the site maps to “site shipping charge” account, “cash” orders from the site get deposited to the “undeposited funds” account, etc.) Mappings from part one are illustratively, for the most part, hard coded in software in the intermediary service layer, although it can be collected as a user preference (e.g., during sign-up) and stored in the service layer. Mappings from the second part are illustratively stored in the client application itself and can be configured either through application user interfaces or through online user interfaces (e.g., service layer interfaces) and subsequently communicated back to the application. Those skilled in the art will appreciate that other configurations are also within the scope of the present invention. For example, the part two mappings can be stored in the service layer (e.g., and not in the client application).

As is indicated by arrow 233, the registration process (e.g., the mapping and account set up processes) can be repeated for some or all of sites 120, 122 and 124. The registration process can be the same from one site to the next or it may be different. The process can be customized to the requirements of each site.

In accordance with block 240, user 104 is able to set other preferences, such as other parameters to be applied by service 110. For example, a user can provide system 110 with instructions as to how to handle the processing of a sale or item listing that didn't originate from application 102 (e.g., setting determines whether related information is or is not automatically incorporated with other listing information into application 102, etc.). The parameters are illustratively also collected through application 102 interfaces and transmitted to service 110 if necessary. In accordance with block 242, once the registration process is complete and the service has been activated, inventory is reserved at step 216, listing request 220 is created/transmitted, listings 222 are created appropriately and the listing process is complete.

It should be noted that registration process 230 is not necessarily limited to first time users of intermediary service 110. As was mentioned in relation to box 212, user 104 is able to select one or more E-commerce sites with which the listing will be included. It is conceivable that, at block 212, the user may have selected a new E-commerce site despite the fact that the user already has service 110 set up for a different site. In this case, registration process 230 is carried out so as to set up the new service. In other words, the existing user of intermediary service 110 is directed through at least a portion of the registration process to set up the intermediary service for the newly selected E-commerce site.

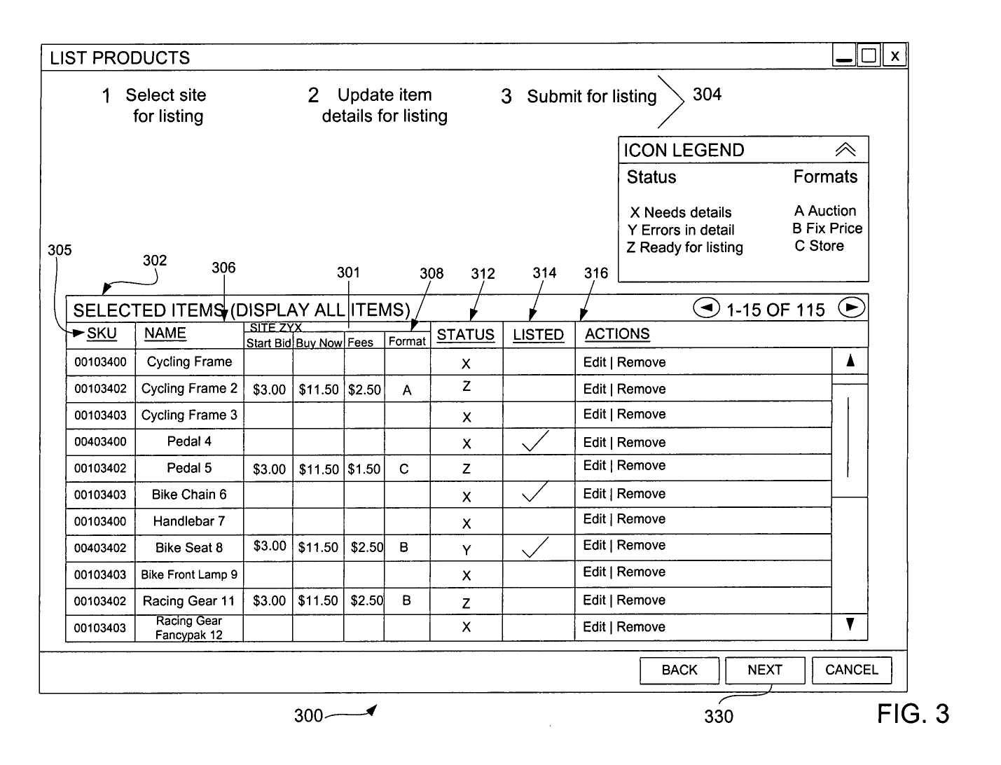

FIG. 3 is an example of a screenshot 300 that is provided to user 104 through application 102 as part of the initial listing process. As is generally indicated within a workflow indicator area 304, screenshot 300 is associated with the second step in a three-step process that enables the user to utilize application 102 to submit a listing request. The first step in the process, for which a screenshot has not been provided, involves selecting a particular E-commerce site on which at least one new listing is desired. This is similar to step 210 in process 200. It will be assumed that the first step has been completed and, as is indicated by tab 301, a single site called “ZYX” was selected. The second step involves identifying sale parameters to be incorporated into the listing request for one or more sale items. This is similar to step 208 in process 200. Finally, the third step involves submitting information compiled in step two for listing. This is similar to the transfer of listing request 220 described in relation to process 200.

Screenshot 300 enables the user to review the status of multiple items simultaneously. Screenshot 300 includes a table 302 of items in various listing states relative to site ZYX, the E-commerce site selected in the first step. For each item, column 306 contains the item name and column 307 contains the item SKU number. Values related to the relevant starting bid, buy now amount and fee amounts are provided if available. Column 308 contains an indicator as to the format of sale assigned to the item. The values in column 308 are interpreted by the user based on an icon legend 310. Column 312 contains an indicator of the listing status for each item. The values in column 312 are also explained in legend 310. Column 314 indicates whether the item has already been submitted for listing and listed. Column 316 provides a control that enables the use to remove a particular item from the table. Pressing a next button 330 will illustratively lead the user to the third step in the process, namely, the submission for listing of items in the table that are ready for listing (i.e., items with an “Z” indicator in column 312).

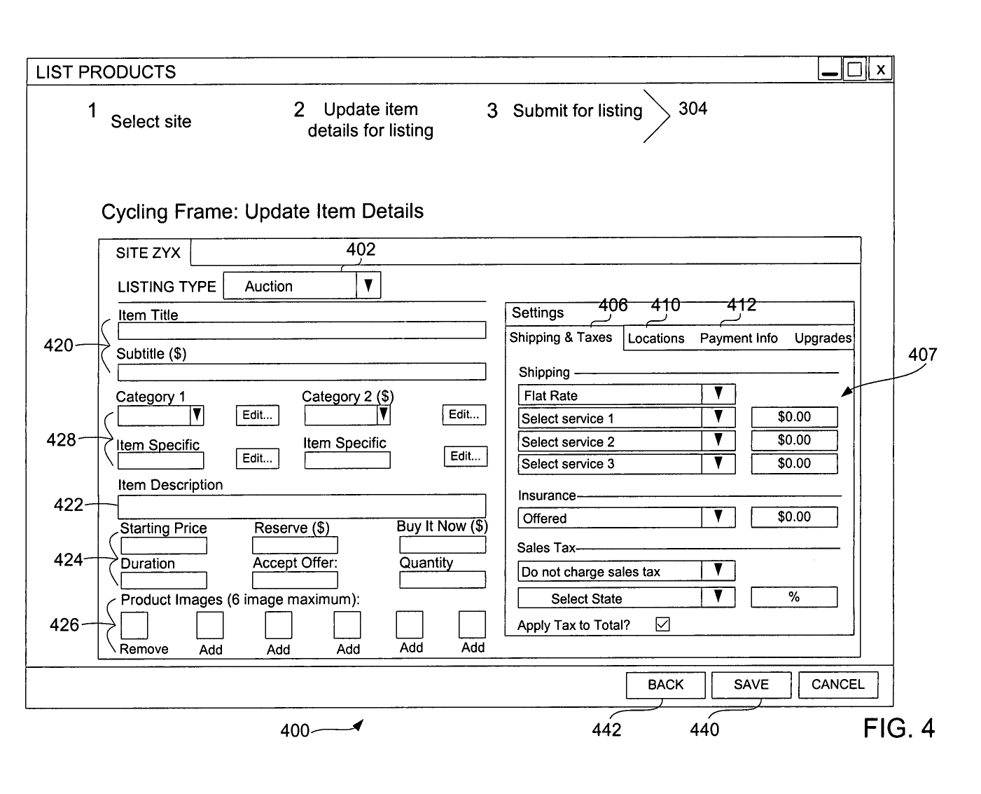

Column 316 also provides a control for editing an item. Selecting the edit function illustratively leads to an item-specific screenshot view (updated with as much data as has been previously input) such as one similar to screenshot 400 in FIG. 4.

Screenshot 400 is an interface that enables the user to identify an item and enumerate sales parameters for incorporation into the listing request and, eventually, a corresponding listing on the selected site. It should be noted that different E-commerce sites may require or support different sales parameters. In one embodiment, the configuration of the components of screenshot 400 are specific to the selected E-commerce site (i.e., site ZYX in the illustrated case). Similarly, the column 312 determination in FIG. 3 as to whether an item is “ready for listing” may be a site-specific determination contingent upon what is required by a particular site.

Some of the components of screenshot 400 will now be described in greater detail. A control 402 enables the user to select a type parameter indicative of a particular type of listings (e.g., auction, fixed price, classic store type, etc.). A tabbed area 406 enables the user to input, within a sub-window area 407, shipping, insurance and sales tax parameters. Should the user select tab 410, the sub-window area 407 transitions into a set of controls that enable the user to input location parameters such as parameters related to where the item is located (e.g., country, city, etc.), whether the seller is willing to ship and, if so, to where the seller is willing to ship, etc. Should the user select tab 412, the sub-window area 407 transitions into a set of controls that enable the user to input payment parameters such as parameters related to payment instructions and/or accepted payment methods (e.g., money order, check, certain credit cards, third party payment providers, etc.), etc. In fields 420, the user is able to enter title and subtitle information. Field 422 supports entry of an item description. Fields 424 enables the user to set parameters related to the duration of the listing, the starting price, a reserve price, quantity available, a buy it now price, etc. Area 426 supports the attachment of related photographs (e.g., from the users computer, from a folder associated with application 102, etc.).

Area 428 enables the user to select one or more categories to which the sale item will be assigned. In one embodiment, clicking on one of the “edit” buttons opens a separate interface component configured to simplify the process of assigning categories, sub-categories etc. The separate interface illustratively includes a visual, hierarchically-organized representation of categories known to be utilized by the E-commerce site selected in the first step of the three step listing process (e.g., utilized by site ZYX). By making selections relative to the representation in the separate interface, the user selects categories that are known in advance to be recognized by the selected site.

Screenshot 400 includes a save button 440. Button 440 enables the user to save data entered into the interface. A back button 442 illustratively returns the user to the collective view of screenshot 300. Table 302 is illustratively updated to reflect changes made within the item-specific view of screenshot 400. In one embodiment, a function is provided for adding a new item to table 302, wherein details related to the new item are input through a an interface such as screenshot 300, and then table 302 is updated accordingly.

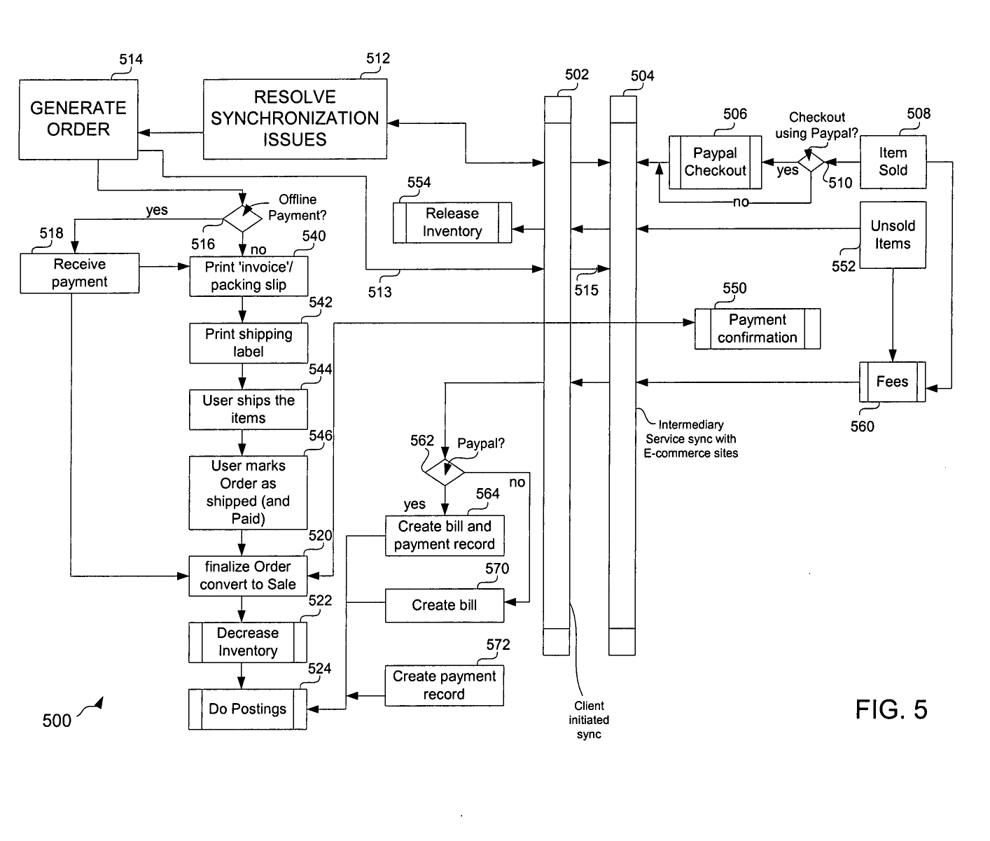

FIG. 5 is a schematic process diagram of a post listing process 500 that is, in one embodiment, applied within system 100 (FIG. 1). Those skilled in the art will appreciate that the details of the process flow could vary greatly from one implementation to the next. Flow 500 is but one example of a flow within the scope of the present invention.

Within process 500, boxes 502 and 504 are illustratively synchronization functions facilitated by intermediary service 110. Specifically, these functions pertain to facilitation of a transfer of transaction oriented information either from an E-commerce site (e.g., site 120, 122 and/or 124) to application 102, or from application 102 to an E-commerce site. In one embodiment, synchronization might be user-initiated (e.g., a user request to synchronize data since previous download, etc.) or automatic (e.g., synchronization occurs automatically on a scheduled periodic basis, etc.).

Within FIG. 5, with the possible exception of box 506, process components to the right of box 504 are illustratively facilitated in the context of an E-commerce site (e.g., site 120, 122 and/or 124). Process components to the left of box 502 are illustratively facilitated in the context of application 102. The illustrated configuration is exemplary only and it is to be understood that process items can be moved from one context to another without departing from the scope of the present invention.

In accordance with box 508, a customer 126 purchases an item associated with a listing on an E-commerce site. At box 510, a determination is made as to whether the customer 126 is to utilize a third party payment service (shown in FIG. 1 as payment service 150) to facilitate payment. It should be noted that services offered by Ebay Inc. are but one example of third party payment services that can be implemented into the process. If third party payment services are to be utilized then, in accordance with box 506, the customer interacts with the service provider and arranges for payment. In one embodiment, when intermediary service 110 facilitates synchronization, an indication of the sale is transmitted from the E-commerce site to application 102.

In accordance with block 512, once application 102 has received the indication of the sale, synchronization issues are resolved as necessary. In the context of listing process flow 200 (FIG. 2), it was described how registration may involve a process of enabling a user to establish how data from a particular E-commerce site will map into application 102 (e.g., what kind of payments map to which application accounts, etc.). In one embodiment, block 512 represents interaction with user 104 in order to resolve any mapping issues that were not taken care during a registration process. The point of 512 is to avoid a scenario wherein there is no established plan implemented to deal with a particular type of data received from the E-commerce site (through synchronization facilitated by intermediary service 110).

In accordance with block 514, once any outstanding synchronization issues have been resolved, an order is generated within application 102, the order being an application-based representation of the sale indication received from the E-commerce service (through synchronization facilitated by intermediary service 110). As is generally indicated by arrows 513 and 515, an indication of the creation of an order may be synchronized with a record maintained on the intermediary service 110. At block 516 a determination is made as to whether payment of the order will occur offline (e.g., a check sent from the customer 126 to user 104 through the mail, hand-delivered cash payment, etc.).

Block 518 represents receipt of an offline payment. User 104 illustratively enters corresponding payment information into application 102 (e.g., the user interacts with accounting application 102 and creates a corresponding cash transaction indicative of the sale). Then, in accordance with block 520, the order is converted to a “sale” within application 102. In accordance with block 522, the application inventory is decreased as to reflect the fact that the sold item is no longer available. Finally, in accordance with block 524, account postings are made so as to be indicative of the sale (e.g., made consistent with synchronization mapping preferences, etc.).

Once an offline payment has been received, or if it is determined that payment will not be made offline, then, in accordance with block application 102 illustratively facilitates the creation of an invoice and/or a packing slip indicative of the order. Block 542 represents application creation of a shipping label indicative of the order (e.g., a label addressed to the customer 126 that initiated the purchase). In accordance with block 544, user 104 ships the item to the customer (i.e., this occurs outside of the application). It should be noted that the flow could be adjusted to postpone shipment until payment is verified. In accordance with block 546, user 104 interacts with application 102 and marks the order as shipped (and paid if payment has been received). Finally, in accordance with blocks 520, 522 and 524, the order is finalized and converted into a sale, and inventory adjustments and postings are made ad appropriate.

In accordance with block 550, during synchronization, an indication of an electronic payment may be communicated to application 102 (e.g., indication that payment was successfully facilitated by third party online payment service 150, an indication that credit card payment to the site was received, etc.). These payments, which assumedly are credited to accounts maintained by user 104, are posted to application 102 accounts based on the established mapping settings. As is shown in FIG. 5, application 102 convert the order to a sale, decreases inventory and posts adjustments to accounts after payment conformation 550 has been received.

As is indicated by block 552, some items listed on the E-commerce site may go unsold. In accordance with block 554, application 102 can be configured to allow an unsold item to revert back into the application 102 inventory following a listing that did not end in a sale. In one embodiment, during synchronization (e.g., facilitated by service 110) unsold items are identified and application 102 receives a corresponding indication upon which inventory adjustments are made as necessary.

Block 560 represents listing fees charged by the E-commerce site. In one embodiment, during synchronization (e.g., facilitated by service 110) fees 560 are identified and application 102 receives a corresponding indication. Based on the indication, in accordance with block 562, a determination is made as to whether a third party payment service will be utilized to pay the fees. If so, in accordance with block 564, application 102 creates both a bill and payment record indicative that payment has been made through the third party service. In accordance with block 524, postings are made accordingly (e.g., made consistent with synchronization mapping preferences, etc.).

If fee payment is not to occur through a third party payment service the, in accordance with block 570, application 102 is configured to create a bill record. In accordance with block 572, a separate payment record is created so as to be consistent with the alternate means of payment. In accordance with block 524, postings are made accordingly (e.g., made consistent with synchronization mapping preferences, etc.).

In one embodiment, user 104 can interact with application 102 so as to request a summary of active listings for a given E-commerce site (i.e., a summary presented through an interface associated with application 102 and/or support component 106).

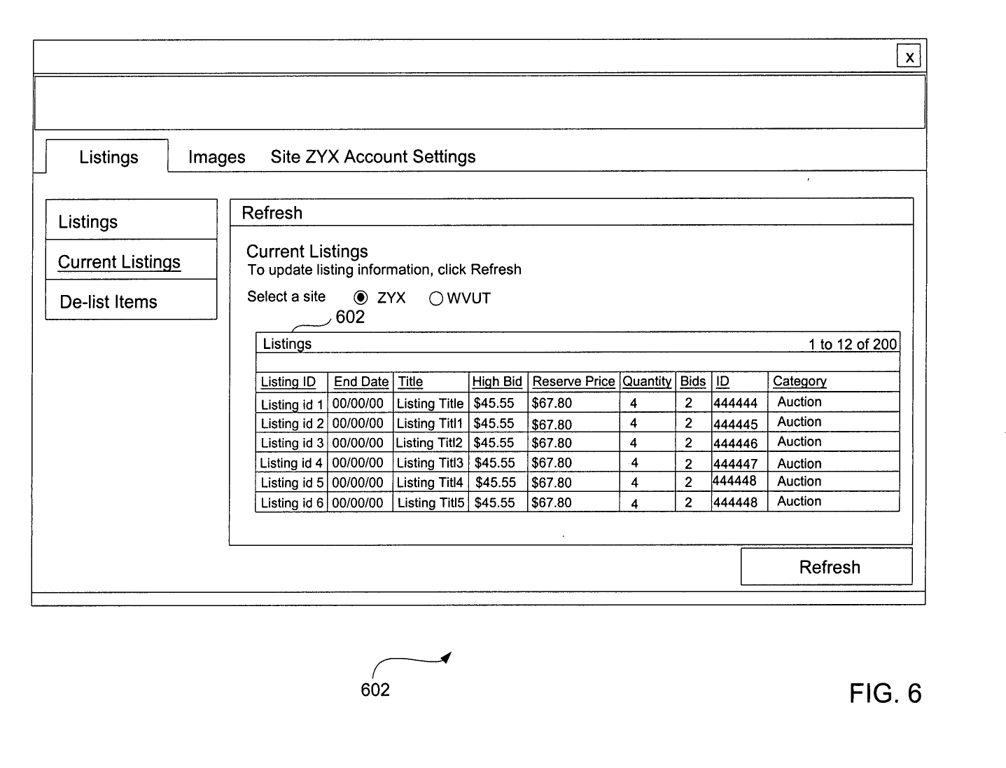

FIG. 6 is an example of a screenshot 600 that is provided to user 104 through application 102 in response to a request for a summary of active listings. Screenshot 600 includes a table of active listings 602. The listings in table 602 are illustratively specific to site ZYX. The user can change table 602 to include listings for a different site by making a different selection in area 604. For each active listing in table 602, a variety of corresponding information is presented in the table. Some of the information may be derivable from records maintained by application 102 and/or intermediary service 110 (e.g., listing request includes auction end date, reserve price, etc.). Other information may need to be retrieved from the site itself (e.g., current high bid, number of bids, etc.). In one embodiment, intermediary service 110 is configured to collect data from a site or sites as necessary to support a report interface associated with application 102 (e.g., an interface such as screenshot 600).

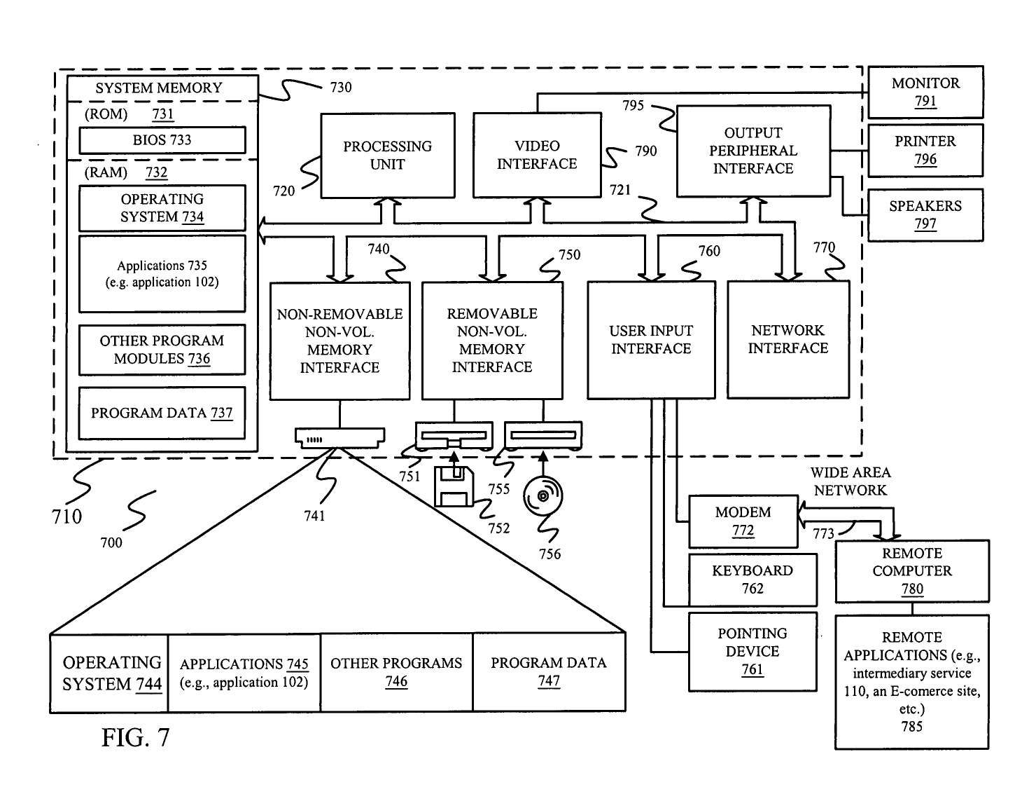

FIG. 7 illustrates an example of a suitable computing system environment 700 in which embodiments may be implemented. The computing system environment 700 is only one example of a suitable computing environment and is not intended to suggest any limitation as to the scope of use or functionality of the claimed subject matter. Neither should the computing environment 700 be interpreted as having any dependency or requirement relating to any one or combination of components illustrated in the exemplary operating environment 700.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments have been described herein in the general context of computer-executable instructions, such as program modules, being executed by a computer. Generally, program modules include routines, programs, objects, components, data structures, etc. that perform particular tasks or implement particular abstract data types. Embodiments can be practiced in distributed computing environments where tasks are performed by remote processing devices that are linked through a communications network. In a distributed computing environment, program modules can be located on both (or either) local and remote computer storage media including memory storage devices.

With reference to FIG. 7, an exemplary system for implementing some embodiments includes a general-purpose computing device in the form of a computer 710. Components of computer 710 may include, but are not limited to, a processing unit 720, a system memory 730, and a system bus 721 that couples various system components including the system memory to the processing unit 720.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737. As is indicated, programs 735 may include an application 102, such as is described in relation to FIG. 1.

The computer 710 may also include other removable/non-removable volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 7, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. As is indicated, programs 735 may include an application 102, such as is described in relation to FIG. 1.

A user may enter commands and information into the computer 710 through input devices such as a keyboard 762 and a pointing device 761, such as a mouse, trackball or touch pad. Other input devices (not shown) may include a joystick, game pad, microphone, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 is operated in a networked environment using logical connections to one or more remote computers, such as a remote computer 780. The logical connection depicted in FIG. 7 is a wide area network (WAN) 773, but may also or instead include other networks. Computer 710 includes a modem 772 or other means for establishing communications over the WAN 773, such as the Internet. The modem 772, which may be internal or external, may be connected to the system bus 721 via the user-input interface 760, or other appropriate mechanism. By way of example, and not limitation, FIG. 7 illustrates remote application programs 785 as including the functionality of intermediary service 110 and/or an E-commerce site, as are described in relation to FIG. 1.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for supporting integration of electronic commerce functionality into an application, the system comprising:
an application;
an electronic marketplace;
an intermediary service layer that is configured to receive a collection of listing information from the application, and being further configured to electronically communicate a representation of the collection of listing information to the electronic marketplace.

2. The system of claim 1, wherein the intermediary service layer is remotely disposed from the electronic marketplace.

3. The system of claim 1, wherein the intermediary service layer is remotely disposed from the application.

4. The system of claim 1, wherein the intermediary service layer is remotely disposed from the electronic marketplace and the application.

5. The system of claim 1, wherein the intermediary layer is configured to electronically communicate a representation of the collection of listing information to the electronic marketplace and at least one other electronic marketplace.

6. The system of claim 1, wherein the intermediary layer is configured to facilitate a mapping of financial information received from the electronic marketplace to an account maintained within the application.

7. The system of claim 1, wherein the intermediary layer is configured to receive a credential from the application and authenticate the credential with the electronic marketplace.

8. The system of claim 1, wherein the intermediary layer is configured to receive an indication of a sale from the electronic marketplace and forward a representation of the indication to the application.

9. The system of claim 1, wherein the intermediary layer is configured to receive an indication of an unsold item and forward a representation of the indication to the application.

10. The system of claim 1, wherein the intermediary layer is configured to receive an indication of a fee charged by the electronic marketplace and forward a representation of the indication to the application.

12. An application having integrated support for electronic commerce, the application component configured to set a mapping preference that links a type of information to be received from a remotely disposed electronic commerce site to a component within the application.

13. The application of claim 12, wherein the mapping preference is prospectively set before the type of information is actually received.

14. The application of claim 12, wherein when said type of information is received, it is received from the remotely disposed electronic commerce site by way of an intermediary service layer.

15. The application of claim 14, wherein the mapping preference links an entity associated with the electronic commerce site to an account associated with the application.

16. The application of claim 12, wherein the mapping preference links a type of financial information to an account maintained within the application.

17. The application of claim 16, wherein the application is configured to automatically or semi-automatically make a debit or credit against the account when said type of financial information is received.

18. An intermediary service layer for supporting integration of electronic commerce functionality into an application, wherein the intermediary service layer is configured to receive a collection of listing information from an application and electronically communicate the collection of listing information to an electronic marketplace.

19. The intermediary service layer of claim 18, wherein the layer is remotely disposed from the electronic marketplace.

20. The intermediary service layer of claim 18, wherein the layer is remotely disposed from the application.
